(19) United States
(12) Patent Application Publication
(10) Pub. No.: US 2007/0247079 A1
(43) Pub. Date: Oct. 25, 2007

(54) Arc furnace power supply device

(75) Inventors: Daniel Sager, Nussbaumen (CH); Yongsug Suh, Untersiggenthal (CH); Yongjoong Lee, Baden-Dattwil (CH); Henrik Nordborg, Baden (CH)

Correspondence Address: BUCHANAN, INGERSOLL & ROONEY PC, POST OFFICE BOX 1404, ALEXANDRIA, VA, 22313-1404, US

(73) Assignee: ABB Schweiz AG, Baden (CH)

(21) Appl. No.: 11/785,857

(22) Filed: Apr. 20, 2007

(30) Foreign Application Priority Data
Apr. 21, 2006 (EP) 06405172.5

(51) Int. Cl. H05B 37/00

(52) U.S. Cl. 315/200 R

(57) ABSTRACT

An arc furnace power supply device with a rectifier is specified, which rectifier on its alternating voltage side can be connected with an electrical alternating voltage supply network and on its direct voltage side is connected with a direct voltage circuit. Moreover the arc furnace power supply device comprises an inverter, which inverter on its direct voltage side is connected with the direct voltage circuit and on its alternating voltage side with at least one arc electrode. For improvement of the stability and even burning of the arc the inverter is configured as an inverter that applies a rectangular alternating voltage to the arc electrode.

### RELATED APPLICATIONS

This application claims priority under 35 U.S.C. §119 to EP Application 06405172.5 filed in Europe on Apr. 21, 2006, the entire contents of which are hereby incorporated by reference in their entireties.

### TECHNICAL FIELD

This disclosure relates to the field of arc furnaces and arc furnace power supply devices.

### BACKGROUND INFORMATION

Arc furnaces are today primarily used for the heating and melting of metals, in particular steel or aluminium. For this purpose such an arc furnace has a crucible to accommodate the material to be heated and/or melted. Such an arc furnace is typically supplied with energy by an arc furnace power supply device for the heating and/or melting. A suitable arc furnace power supply device is specified in EP 1 174 004 B1. In this the arc furnace power supply device has a rectifier, which rectifier can be connected on its alternating voltage side with an electrical alternating voltage supply network. On the direct voltage side the rectifier is connected with a direct voltage circuit. Moreover the arc furnace power supply device comprises an inverter, which inverter on its direct voltage side is connected with the direct voltage circuit and on its alternating voltage side with at least one arc electrode. The inverter of EP 1 174 004 B1 is furthermore designed as an inverter that applies a sinusoidal alternating voltage to the arc electrode.

What is problematical in an arc furnace power supply device as described above is that as a result of the application of the sinusoidal alternating voltage to the arc electrode by means of the inverter the arc that is thereby generated on the arc electrode can become unstable and as a consequence no longer burns evenly in the desired manner. For this reason, however, an adequate and even heating of the material to be heated and/or an adequate and even melting of the material to be melted is no longer guaranteed.

### SUMMARY

An arc furnace power supply device is disclosed with which a stable and even arc can be generated. An exemplary arc furnace power supply device has a rectifier, which rectifier can be connected on its alternating voltage side with an electrical alternating voltage supply network. On the direct voltage side the rectifier is connected with a direct voltage circuit. Moreover the arc furnace power supply device has an inverter, which inverter on its direct voltage side is connected with the direct voltage circuit and on its alternating voltage side with at least one arc electrode. An exemplary inverter is configured as an inverter that applies a rectangular alternating voltage to the arc electrode. As a result of the rectangular alternating voltage applied to the arc electrode by means of the inverter the arc resistance reduces in a significant manner as the arc electrode current passes through zero, and the current gradient di/dt increases as the arc electrode current passes through zero, whereby the arc can advantageously be stabilised and for this reason burns more evenly.

### BRIEF DESCRIPTION OF THE DRAWINGS

These and further objectives, advantages and features of the present invention are evident from the following detailed description of examples of embodiment in conjunction with the drawing. In the figures:

FIG. 1 shows a first exemplary embodiment of an arc furnace power supply device,

FIG. 2 shows a second exemplary embodiment of an arc furnace power supply device,

FIG. 3 shows a third exemplary embodiment of an arc furnace power supply device,

FIG. 4 shows a fourth exemplary embodiment of an arc furnace power supply device.

The reference symbols used in the drawing and their significance are summarily listed in the reference symbol list. As a matter of principle the same parts are provided with the same reference symbols in the figures. The described exemplary embodiments are by way of example, but are not meant to be restrictive.

### DETAILED DESCRIPTION

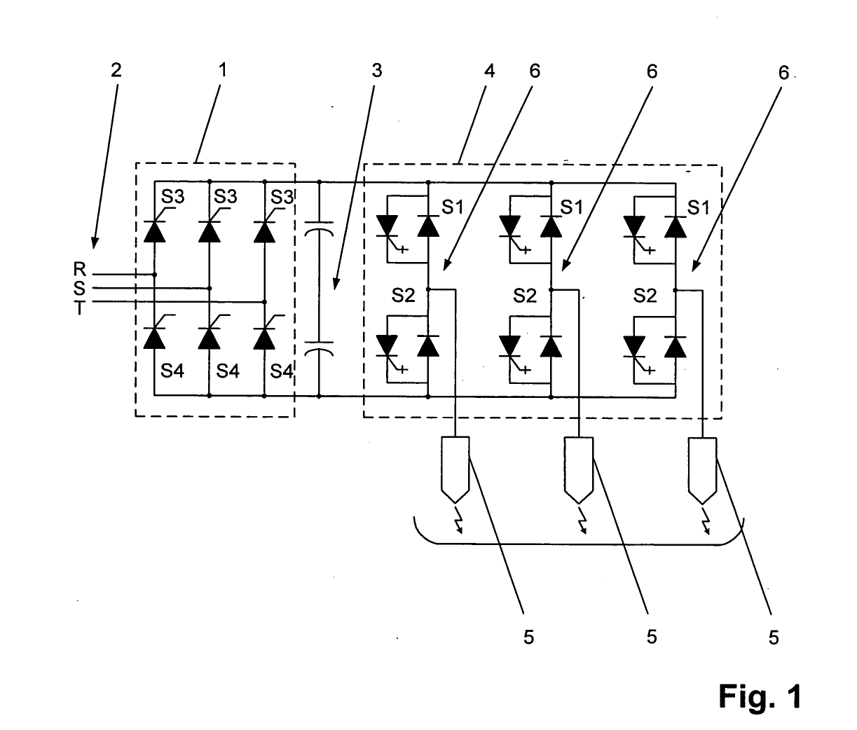

In FIG. 1 is represented a first exemplary embodiment of the arc furnace power supply device. In this the arc furnace power supply device comprises a rectifier 1, which rectifier can be connected on its alternating voltage side with an electrical alternating voltage supply network 2. The connection can be effected directly via a power supply switch, not represented in the interests of clarity, and/or via one or a plurality of transformers with appropriate voltage levels. On the direct voltage side the rectifier 1 according to FIG. 1 is connected with a direct voltage circuit 3. The direct voltage circuit 3 can be formed by one or a plurality of capacitive energy stores, as shown in FIG. 1 in an exemplary manner. Moreover the arc furnace power supply device has an inverter 4, which inverter 4 on its direct voltage side is connected with the direct voltage circuit 3 and on its alternating voltage side with at least one arc electrode 5, wherein in FIG. 1 in an exemplary manner three arc electrodes connected with the inverter 4 are provided. The exemplary inverter 4 is configured as an inverter that applies a rectangular alternating voltage to the arc electrode. The inverter is thus configured such that it generates a rectangular alternating voltage, which is then applied to the arc electrode(s) 5. As a result of the rectangular alternating voltage applied to the arc electrode 5 by means of the inverter 4 the arc resistance reduces in a significant manner as the arc electrode current passes through zero, and the current gradient di/dt increases as the arc electrode current passes through zero, whereby the arc can advantageously be stabilised and for this reason burns more evenly.

The frequency of the rectangular alternating voltage can correspond essentially to the frequency of the alternating voltage in the electrical alternating voltage supply network 2, whereby a particularly stable and evenly burning arc can be achieved.

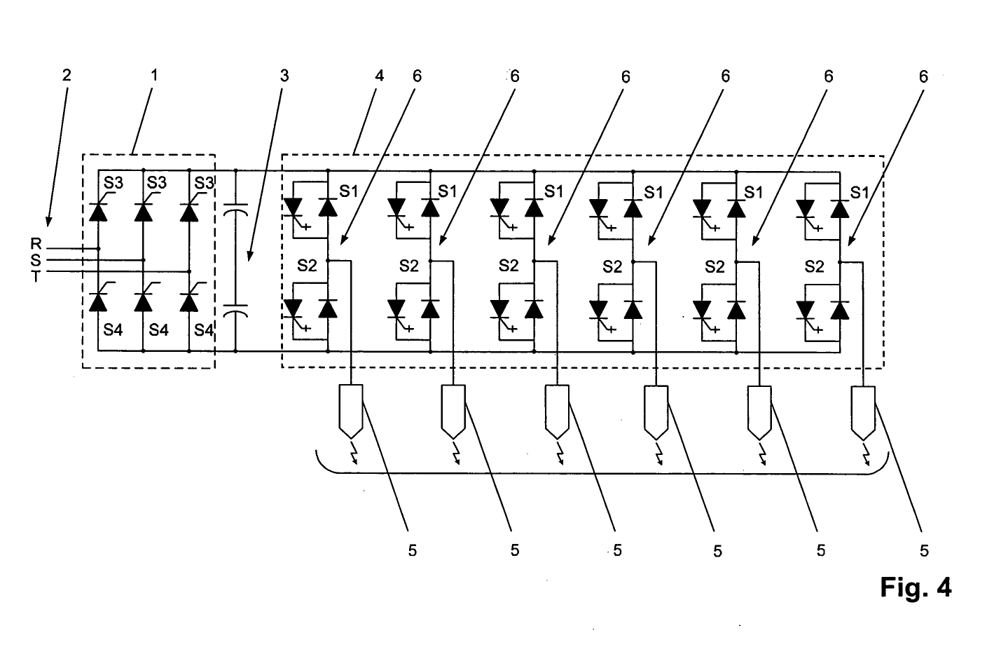

According to FIG. 1 the inverter 4 for each arc electrode 5 has a respective inverter branch pair 6, wherein each inverter branch pair 6 has two controllable bidirectional power semiconductor switches S1, S2 connected in series, and the arc electrode 5 in question is connected with the connection point between the two controllable bidirectional power semiconductor switches S1, S2 connected in series. In the event of a plurality of arc electrodes 5 the respective inverter branch pairs can be connected in parallel. Moreover each inverter branch pair 6 can be connected in parallel with the direct voltage circuit 3. Each of the controllable bidirectional power semiconductor switches S1. S2 can be formed by a gate turn-off thyristor, or by a bipolar transistor with an insulated gate electrode (IGBT), or by an integrated thyristor with a commutated control diode (IGCT), and by a diode connected in antiparallel with the gate turn-off thyristor, or bipolar transistor, or thyristor with commutated control diode. It is however also conceivable, for example, to embody a previously cited controllable bidirectional power semiconductor switch S1. S2 as a power MOSFET with an additional diode connected in antiparallel. By means of the inverter branch pair 6 in question it is advantageously possible to adjust the rectangular alternating voltage on the respective arc electrode 5 with respect to the amplitude and phase, and thereby to influence the stability and even burning of the arc appropriately. Additionally according to FIG. 4 in an exemplary manner, in a fourth exemplary embodiment of the arc furnace power supply device, six arc electrodes 5 connected with the inverter 4 can be provided, so that six inverter branch pairs 6 are then present.

According to FIG. 1 and FIG. 4, the rectifier 1 of the electrical alternating voltage supply network 2 has a series circuit for each phase R. S, T, consisting of two controllable unidirectional power semiconductor switches S3, S4. The series circuits in question are here connected in parallel, and are connected in parallel with the direct voltage circuit 3. Each of the controllable unidirectional power semiconductor switches S3. S4 can be formed by a gate turn-off thyristor or by a bipolar transistor with an insulated gate electrode (IGBT), or by an integrated thyristor with a commutated control diode (IGCT). It is however also conceivable, for example, to design a previously cited controllable unidirectional power semiconductor switch S3, S4 as a power MOSFET.

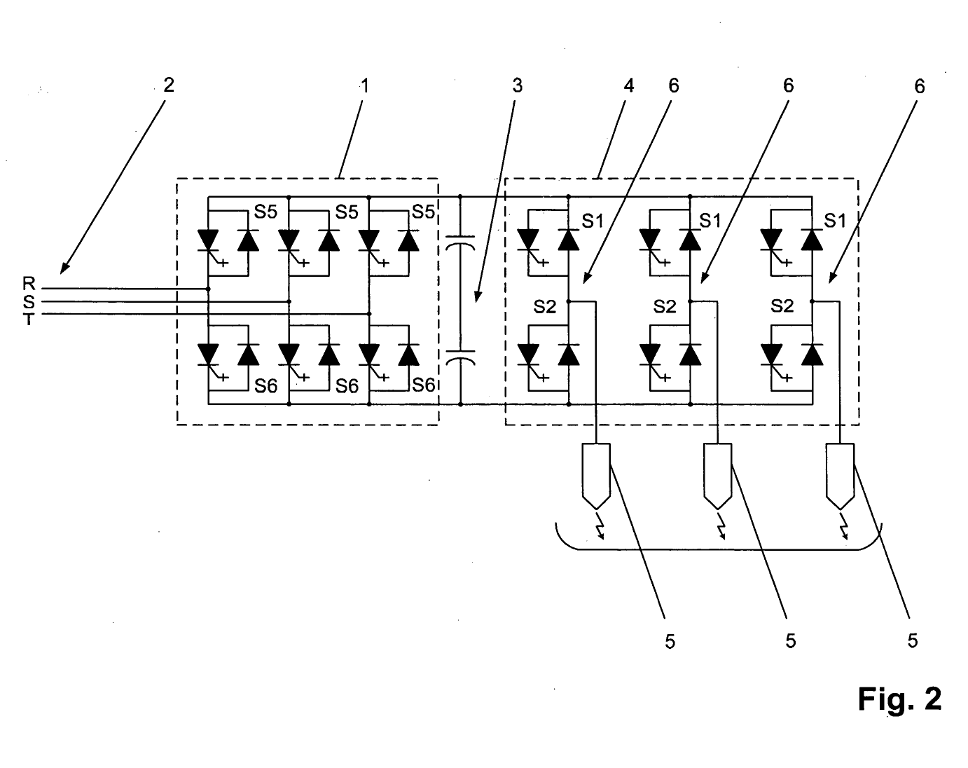

In FIG. 2 is shown a second exemplary embodiment of the arc furnace power supply device. In contrast to the first exemplary embodiment according to FIG. 1, the rectifier 1 has a series circuit for each phase R. S, T of the electrical alternating voltage supply network 2, consisting of two controllable bidirectional power semiconductor switches S5, S6. Each of the controllable bidirectional power semiconductor switches S5. S6 can be formed by a gate turn-off thyristor, or by a bipolar transistor with an insulated gate electrode (IGBT), or by an integrated thyristor with a commutated control diode (IGCT), and by a diode connected in antiparallel with the gate turn-off thyristor, or bipolar transistor, or thyristor with commutated control diode. It is however also conceivable, for example, to embody a previously cited controllable bidirectional power semiconductor switch S5, S6 as a power MOSFET with an additional diode connected in antiparallel. A rectifier 1 implemented in such a manner by means of the previously cited controllable bidirectional power semiconductor switches S5, S6 with advantage generates on the alternating voltage side and direct voltage side only very small harmonics with regard to the alternating voltage in the electrical alternating voltage supply network 2, so that the voltage in the direct current circuit 3 can in addition be adjusted over a wide range.

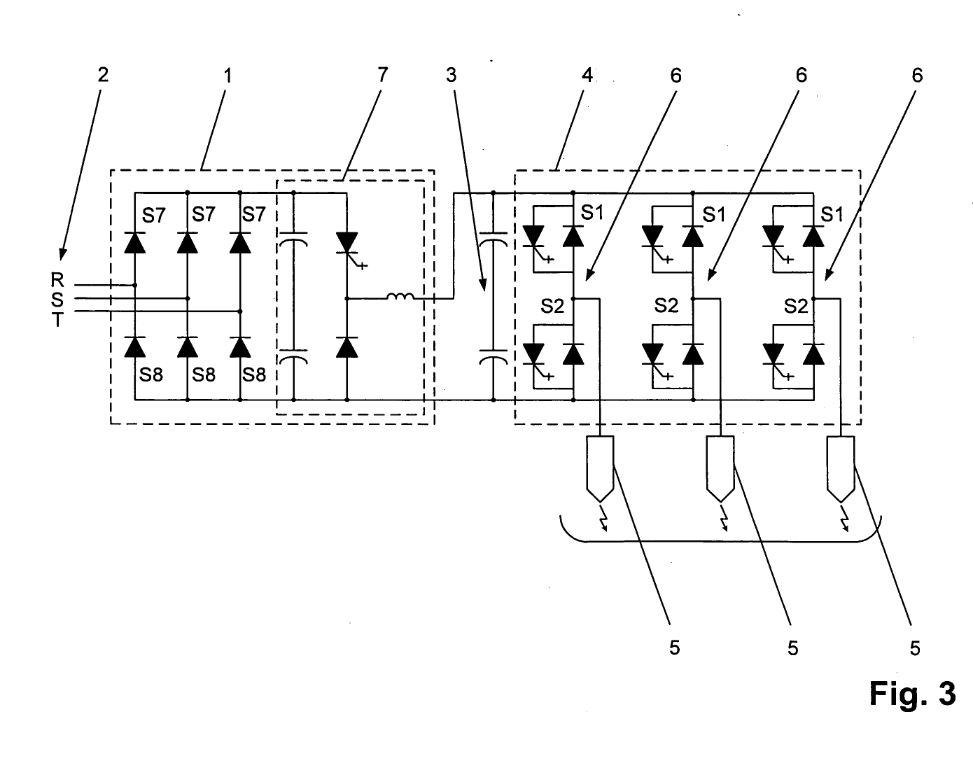

As an alternative to the exemplary embodiments according to FIG. 1 and FIG. 2 the rectifier 1 in a third exemplary embodiment according to FIG. 3 of the exemplary arc furnace power supply device has a series circuit consisting of two passive non-controllable unidirectional power semiconductor switches S7, S8 for each phase R, S, T of the electrical alternating voltage supply network 2. Each of the passive non-controllable unidirectional power semiconductor switches S7, S8 can be formed by a diode. The rectifier 1 implemented according to FIG. 3 represents an extremely robust solution since no kind of control or regulation task exists with regard to the power semiconductor switches S7, S8. If the voltage and current in the direct voltage current 3 are to be adjustable, then optionally according to FIG. 3 an adjuster unit 7 of the rectifier 1 can additionally be provided for the adjustment of the current and voltage in the direct voltage circuit 3, as is shown in an exemplary manner in FIG. 3. If no such adjuster unit 7 is provided, then the series circuits of each of the two passive non-controllable unidirectional power semiconductor switches S7, S8 are connected in parallel and are then moreover connected in parallel with the direct voltage circuit 3.

It should be mentioned that the advantageous rectangular alternating voltage for the arc electrode 4 can also be implemented by means of a matrix inverter that can be connected with the electrical alternating voltage supply network 2.

Advantageously the previous arc furnace power supply device described in detail by means of FIG. 1 to FIG. 4 can find application in an arc furnace.

It will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

### REFERENCE SYMBOL LIST

1 Rectifier
2 Electrical alternating voltage supply network
3 Direct voltage circuit
4 Inverter
5 Arc electrode
6 Inverter branch pair
7 Adjuster unit
S1, S2 Controllable bidirectional power semiconductor switch
S3, S4 Controllable unidirectional power semiconductor switch
S5, S6 Controllable bidirectional power semiconductor switch
S7, S8 Passive non-controllable unidirectional power semiconductor switch

What is claimed is:

1. An arc furnace power supply device with a rectifier, which rectifier on its alternating voltage side can be connected with an electrical alternating voltage supply network and on its direct voltage side is connected with a direct voltage circuit, with an inverter, which inverter on its direct voltage side is connected with the direct voltage circuit and on its alternating voltage side with at least one arc electrode,
wherein the inverter is configured as an inverter that applies a rectangular alternating voltage to the arc electrode.

2. The arc furnace power supply device according to claim 1,
wherein the frequency of the rectangular alternating voltage essentially corresponds to the frequency of the alternating voltage in the electrical alternating voltage supply network.

3. The arc furnace power supply device according to claim 1, wherein the inverter for each arc electrode has a respective inverter branch pair, wherein
each inverter branch pair has two controllable bidirectional power semiconductor switches connected in series, and the respective arc electrode is connected with the connection point between the two controllable bidirectional power semiconductor switches connected in series.

4. The arc furnace power supply device according to claim 3, wherein in the event of a plurality of arc electrodes the respective inverter branch pairs are connected in parallel.

5. The arc furnace power supply device according to claim 1, wherein the rectifier has a series circuit consisting of two controllable unidirectional power semiconductor switches for each phase of the electrical alternating voltage supply network.

6. The arc furnace power supply device according to claim 1, wherein the rectifier has a series circuit consisting of two controllable bidirectional power semiconductor switches for each phase of the electrical alternating voltage supply network.

7. The arc furnace power supply device according to claim 1, wherein the rectifier has a series circuit consisting of two passive non-controllable unidirectional power semiconductor switches for each phase of the electrical alternating voltage supply network.

8. The arc furnace power supply device according to claim 7, wherein the rectifier has an adjuster unit for the adjustment of the current and voltage in the direct voltage circuit.

9. An arc furnace, which has an arc furnace power supply device according to claim 1.

10. The arc furnace power supply device according to claim 2, wherein the inverter for each arc electrode has a respective inverter branch pair, wherein
each inverter branch pair has two controllable bidirectional power semiconductor switches connected in series, and the respective arc electrode is connected with the connection point between the two controllable bidirectional power semiconductor switches connected in series.

11. The arc furnace power supply device according to claim 4, wherein the rectifier has a series circuit consisting of two controllable unidirectional power semiconductor switches for each phase of the electrical alternating voltage supply network.

12. The arc furnace power supply device according to claim 4, wherein the rectifier has a series circuit consisting of two controllable bidirectional power semiconductor switches for each phase of the electrical alternating voltage supply network.

13. The arc furnace power supply device according to claim 4, wherein the rectifier has a series circuit consisting of two passive non-controllable unidirectional power semiconductor switches for each phase of the electrical alternating voltage supply network.

14. An arc furnace, which has an arc furnace power supply device according to claim 8.

15. An arc furnace power supply device, comprising:
a rectifier having an alternating voltage side for connection with an electrical alternating voltage supply network, and a direct voltage side for connection with a direct voltage circuit, and
an inverter having a direct voltage side for connection with the direct voltage circuit, and
an alternating voltage side with at least one arc electrode, wherein the inverter applies a rectangular alternating voltage to the arc electrode.
